(19) United States
(12) Patent Application Publication
(10) Pub. No.: US 2019/0261598 A1
(43) Pub. Date: Aug. 29, 2019

(54) ELEVATED PET BED

(71) Applicant: Matthew Douglas Moher, SPOKANE, WA (US)

(72) Inventor: Matthew Douglas Moher, SPOKANE, WA (US)

(21) Appl. No.: 16/281,508

(22) Filed: Feb. 21, 2019

Related U.S. Application Data
(63) Continuation of application No. 62/634,846, filed on Feb. 24, 2018.

(51) Int. Cl. A01K 1/035; F16M 11/22

(52) U.S. Cl. CPC A01K 1/0353; F16M 11/22

(57) ABSTRACT

An elevated pet bed with a paired set of fabrics, comprising a sleeved base fabric and a removable top fabric, wherein the top fabric covers and protects the base fabric and fastens to the underside of the base fabric by way of an attachment means. The sleeved base fabric traverses horizontal frame members of the elevated pet bed for support and horizontal frame members connect to vertical members to provide elevation.

### CROSS-REFERENCE TO RELATED APPLICATION

This application claims the benefit of U.S. Provisional Patent Application No. 62/634,846, filed Feb. 24, 2018, which is incorporated by reference herein in its entirety.

### TECHNICAL FIELD

The present disclosure relates generally to the field of pet beds. More specifically, the present disclosure relates to improvements for an elevated pet bed.

### BACKGROUND OF THE INVENTION

Similar to the first human beds, many pet beds lie directly on the ground. However, many animals, like humans, prefer to sleep on an elevated surface. An elevated pet bed is a device that allows dogs and other pets to evade cold drafts, dirt, and pests. In warm weather the airflows beneath the elevated sleeping surface and delivers the pet a cooling effect. The elevated sleeping surface consists of a single-layer, breathable base fabric with sleeves through which a horizontal frame member traverses in order to provide support. The horizontal frame members are connected to vertical members, which provide the elevation.

Due to both the curiousness and destructive nature of many pets, and dogs in particular, elevated pet beds are particularly prone to damage. The breathable base fabrics are especially vulnerable to long nails and chewing. It is common practice to replace torn and damaged base fabrics thereby extending the life of the elevated pet bed. This is not trivial, as the elevated frame needs to be deconstructed to replace the base fabric.

To provide the pets orthopedic support, suitable base fabrics require a degree of elasticity. Base fabrics lose their elasticity over extended usage such that they fail to adequately support the pet. Said base fabrics may be replaced to extend the life of the elevated pet bed.

The susceptibility of wear and tear to base fabrics and the related expense of replacing said fabrics, has prompted consumers to place a multitude of devices on top of the base fabric. These devices include, but are not limited to, floor pet beds, blankets, towels, and even diaper-like fabrics for puppies and dogs with incontinence.

There is an inherent issue with these stopgap devices. Mainly, the devices are not securely attached and they slip off to expose the base fabric, thereby thwarting their intended purpose.

Therefore, what is needed is an elevated pet bed with fastened, protective paired fabrics, which overcome the susceptibility to damage and deterioration of prior designs.

### SUMMARY OF THE INVENTION

This invention is an elevated pet bed with a paired set of fabrics, defined as a sleeved reinforced stitched base fabric and a removable top fabric comprised of a multitude of materials, wherein the top fabric covers the base fabric and fastens securely to the underside of the base fabric by way of an attachment means. Four lineal hook-and-loop strips are stitched to the underside of the base fabric and four matching lineal hook-and-loop strips are stitched to the underside of the top fabric. To deliver a bond secure enough to overcome a pet's destructiveness the top fabric's hook-and-loop strips cover the entire length of all four straight sides. The base fabric's hook-and-loop strips length corresponds to the same specifications as the top fabric strips. Elevated pet bed horizontal frame members support the paired set of fabrics and connect to vertical frame members to provide elevation.

For a multitude of reasons, including, but are not limited to, the weather is warm, the pet's nails have been groomed, or the pet bed needs cleaning, it will be desirable to remove the top fabric. The fabric set fastening technology provides a temporary bond, thereby, permitting the elevated pet bed to be used in diverse environments. It is to be understood that the foregoing general description and following detailed description are exemplary and explanatory but are not restrictive.

The invention replaces an elevated pet bed with non-fastened base fabrics and no top fabric with an elevated pet bed with a fastened base fabric and top fabric set.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of an elevated pet bed, according to one embodiment, including a removable top fabric;

FIG. 2 is an perspective view of the underside of a pet bed, according to one embodiment, with a removable top fabric;

FIG. 3 is a perspective view of the underside of an elevated pet bed, according to one embodiment, with the removable top fabric partially opened; and

FIG. 4 is a perspective view of an elevated pet bed, according to one embodiment, with a transparent view of an attachment means.

### DETAILED DESCRIPTION OF THE INVENTION

FIG. 1 is a perspective view of an elevated pet bed 100, according to one embodiment, including a removable top fabric 150. The pet bed 100 includes an elevated frame 110 comprising one or more horizontal frame members 115. The horizontal frame members 115 are held up by one or more vertical members 120.

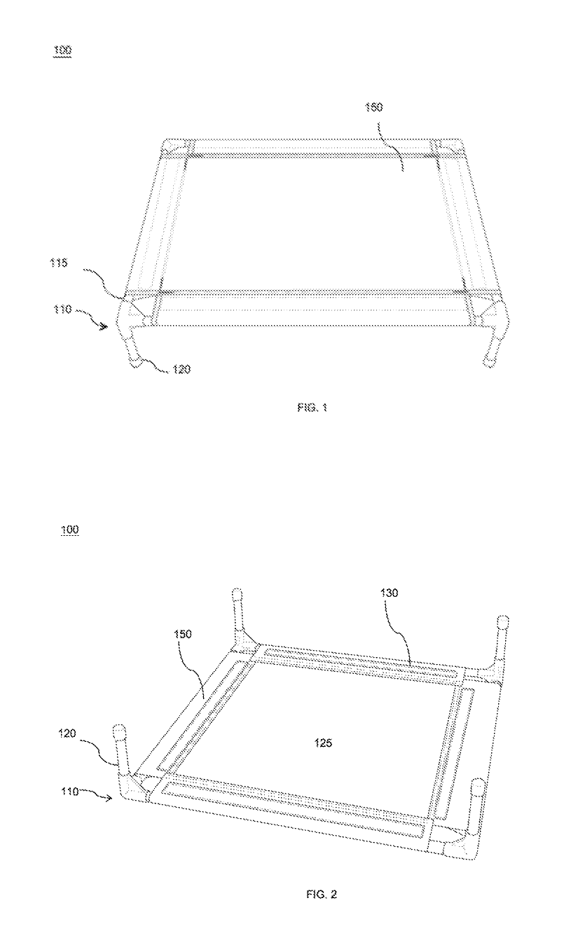

FIG. 2 is a perspective view of the underside of a pet bed 100, according to one embodiment, with a removable top fabric 150. The base fabric 125 is a breathable material and includes a top surface and an underside surface. A form fitted sheet of material is the removable top fabric 150. The top fabric 150 covers the top surface of the base fabric 125 and attaches to the underside surface of the base fabric 125. The top fabric 150 attaches to the base fabric 125 via an attachment means 130. The attachment means 130 may include one or more of the following: a hook and loop material, buckles, snaps, or zippers. In one embodiment, the attachment means 130 may be positioned along all four edges of the top fabric.

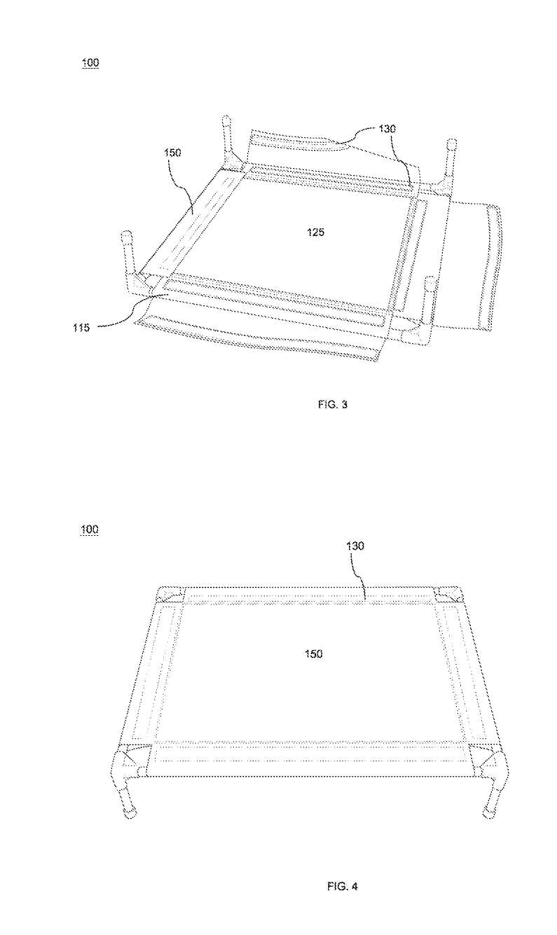

FIG. 3 is a perspective view of the underside of an elevated pet bed 100, according to one embodiment, with the removable top fabric 150 partially opened. The attachment means 130 may traverse the entire length of the top fabric 150, according to one embodiment. In another embodiment, the attachment means 130 may be cut into smaller segments positioned periodically along the underside of the base fabric 125 and along the edge of the top fabric 150.

The base fabric 125 may include one or more sleeved members 135 that extend the length of the frame 110, and through which one or more horizontal frame members 115 traverse. According to one embodiment, the corners of the frame 110 may be exposed such that the sleeved members 135 of the base fabric 125 cover only the elongated portions of the horizontal frame members 115.

FIG. 4 is a perspective view of an elevated pet bed 100, according to one embodiment, with a transparent view of an attachment means 130.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

It will be apparent to those having skill in the art that changes may be made to the details of the above-described embodiments without departing from the underlying principles of the invention. Embodiments of the invention in which an exclusive property or privilege is claimed are defined as follows.

1. A pet bed, comprising:
an elevated frame comprising one or more horizontal frame members suspended by one or more vertical members;
a base sheet forming a stationary fabric comprising one or more sleeved members, wherein the one or more horizontal frame members traverse the one or more sleeved members, and comprising a top surface and an underside surface;
a removable top sheet forming as a top sheet, wherein the removable top sheet covers the top surface of the base fabric and attaches to the underside of the stationary fabric by way of an attachment means.

2. The pet bed of claim 1, wherein the attachment means is comprised of a hook and loop material, one or more buckles, one or more snaps, or one or more zippers.

3. The pet bed of claim 1, wherein the attachment means is positioned along all four edges of the base sheet.
